(19) United States
(12) Patent Application Publication
(10) Pub. No.: US 2019/0215178 A1
(43) Pub. Date: Jul. 11, 2019

(54) ASPECT ORIENTED CONTROL SYSTEM FOR DYNAMIC TOPOLOGY OF UTILITY DEVICES

(71) Applicant: Kasita, Inc., Austin, TX (US)

(72) Inventors: Anthony Polson Pynes, II, Austin, TX (US); Steven Anthony Heidenreich, Austin, TX (US)

(21) Appl. No.: 15/958,963

(22) Filed: Apr. 20, 2018

Related U.S. Application Data
(60) Provisional application No. 62/614,853, filed on Jan. 8, 2018.

(51) Int. Cl. H04L 12/28

(52) U.S. Cl. CPC H04L 12/2809; H04L 2012/285; H04L 2012/2841; H04L 12/2827

(57) ABSTRACT

Environmental control systems and methods of controlling utility devices. The environmental control system includes utility devices and an electronic controller. The electronic controller is configured to sense the utility devices located within a predetermined space and determine capabilities of each sensed utility device. The electronic controller is also configured to determine system functions of the predetermined space based on the capabilities of each sensed utility device. Responsive to receiving an aspect of the predetermined space, the electronic controller is configured to select a system function from the plurality of system functions based on the received aspect. The electronic controller is also configured to determine updated control values for a first subset of the sensed utility devices based on the selected system function and the received aspect. The electronic controller is further configured to send commands to the first subset of sensed utility devices to adjust to the updated control values.

### CROSS-REFERENCE TO RELATED APPLICATION AND CLAIM OF PRIORITY

This application claims priority to U.S. Provisional Application No. 62/614,853, filed Jan. 8, 2018, entitled “ASPECT ORIENTED CONTROL SYSTEM FOR DYNAMIC TOPOLOGY OF UTILITY DEVICES,” which is hereby incorporated by reference in its entirety.

### BACKGROUND

Programmatic interaction with controllable systems of physical devices is currently managed via a specific abstraction per device or a generalized abstraction of the device types. Representing each device as a distinct abstraction creates a system that is rigid and requires changing all consumers of the system when a device is updated, removed, or replaced. In such a system, even devices that have similar functionality require a distinct implementation and controlling convention. Thus, all clients must be aware of which physical device they are controlling and what functionality is offered by that device. Conversely, creating a generalized abstraction of a device type and mapping the devices functionality to that abstraction via a driver program allows for simplifying changes to the system, but does not allow for any non-standard functionality that may be offered by the device. This approach also limits usable devices to those that implement the full generalized representation. In both methods, the system is essentially being defined by the devices (or types of devices) that are part of the system rather than the functionality that the system is intended to have.

### SUMMARY

The disclosure provides an environmental control system. In one embodiment, the environmental control system includes a plurality of utility devices located within a predetermined space and an electronic controller. The plurality of utility devices are configured to manipulate one or more environmental conditions of the predetermined space and report data reflecting control values of the plurality of utility devices. The electronic controller is configured to sense the plurality of utility devices located within the predetermined space and determine one or more capabilities of each of the plurality of sensed utility devices. The electronic controller is also configured to determine a plurality of system functions of the predetermined space based on the one or more capabilities of each of the plurality of sensed utility devices. Each of the plurality of system functions is associated with a subset of sensed utility devices included in the plurality of sensed utility devices. Responsive to receiving an aspect of the predetermined space, the electronic controller is configured to select a system function from the plurality of system functions based on the received aspect of the predetermined space. The selected system function is associated with a first subset of sensed utility devices included in the plurality of sensed utility devices. The electronic controller is also configured to determine updated control values for the first subset of sensed utility devices based on the selected system function and the received aspect of the predetermined space. The electronic controller is further configured to send commands to the first subset of sensed utility devices to adjust to the updated control values.

In some embodiments, responsive to sensing a new utility device located within the predetermined space in addition to the plurality of previously-sensed utility devices, the electronic controller is further configured to determine one or more capabilities of the newly-sensed utility device and determine the plurality of system functions of the predetermined space based on the one or more capabilities of the newly-sensed utility device and the one or more capabilities of each of the plurality of previously-sensed utility devices.

In some embodiments, the electronic controller is further configured to associate the newly-sensed utility device with the selected system function. The electronic controller is also configured to determine an updated control value for the newly-sensed utility device based on the selected system function and the received aspect of the predetermined space. The electronic controller is further configured to send a command to the newly-sensed utility device to adjust to the updated control value.

In some embodiments, responsive to determining that one of the plurality of sensed utility devices is not available upon a subsequent attempt to sense the plurality of sensed utility devices within the predetermined space, the electronic controller is configured to determine the plurality of system functions of the predetermined space based on the one or more capabilities of each of the plurality of remaining sensed utility devices.

In some embodiments, the electronic controller is further configured to determine an updated control value for at least one of the plurality of remaining sensed utility devices and send a command to the at least one of the plurality of remaining sensed utility devices to adjust to the updated control value.

In some embodiments, the received aspect of the predetermined space includes one or more preferred environmental conditions of the predetermined space.

In some embodiments, the received aspect of the predetermined space is without identifiers for the plurality of sensed utility devices.

In some embodiments, the electronic controller is further configured to determine the plurality of system functions of the predetermined space without receiving explicit commands from a user.

The disclosure also provides an environmental control system. In one embodiment, the environmental control system includes a plurality of utility devices located within a predetermined space and an electronic controller. The plurality of utility devices are configured to manipulate one or more environmental conditions of the predetermined space and report data reflecting one or more control values of the plurality of utility devices. The electronic controller is configured to sense the plurality of utility devices located within the predetermined space and determine one or more capabilities of each of the plurality of sensed utility devices. Responsive to receiving an aspect of the predetermined space, the electronic controller is configured to select a subset of sensed utility devices included in the plurality of sensed utility devices based on the received aspect of the predetermined space and the one or more capabilities of each of the plurality of sensed utility devices. The electronic controller is also configured to determine one or more updated control values for the selected subset of sensed utility devices based on the received aspect of the predetermined space. The electronic controller is further configured to send commands to the selected subset of sensed utility devices to adjust to the one or more updated control values.

In some embodiments, the received aspect of the predetermined space includes one or more preferred environmental conditions of the predetermined space.

In some embodiments, the received aspect of the predetermined space is without identifiers for the plurality of sensed utility devices.

The disclosure further provides a method of controlling a plurality of utility devices located within a predetermined space. In one embodiment, the method includes sensing the plurality of utility devices located within the predetermined space with an electronic controller. The method also includes determining one or more capabilities of each of the plurality of sensed utility devices with the electronic controller. The method further includes, responsive to receiving an aspect of the predetermined space at the electronic controller, selecting a first subset of sensed utility devices included in the plurality of sensed utility devices based on the received aspect of the predetermined space and the one or more capabilities of each of the plurality of sensed utility devices. The method also includes determining one or more updated control values for the first subset of sensed utility devices based on the received aspect of the predetermined space with the electronic controller. The method further includes sending commands from the electronic controller to the first subset of sensed utility devices to adjust to the one or more updated control values.

In some embodiments, the received aspect of the predetermined space includes one or more preferred environmental conditions of the predetermined space.

In some embodiments, the received aspect of the predetermined space is without identifiers for the plurality of sensed utility devices.

In some embodiments, the method further includes determining a plurality of system functions of the predetermined space based on the one or more capabilities of each of the plurality of sensed utility devices with the electronic controller. Each of the plurality of system functions is associated with a subset of sensed utility devices included in the plurality of sensed utility devices. The method also includes, response to receiving the aspect of the predetermined space at the electronic controller, selecting a system function from the plurality of system functions based on the received aspect of the predetermined space with the electronic controller. The selected system function is associated with the first subset of sensed utility devices included in the plurality of sensed utility devices. The method further includes determining the one or more updated control values for the first subset of sensed utility devices based on the selected system function and the received aspect of the predetermined space. The method also includes sending commands from the electronic controller to the first subset of sensed utility devices to adjust to the one or more updated control values.

In some embodiments, the method further includes determining the plurality of system functions of the predetermined space with the electronic controller without receiving explicit commands from a user.

In some embodiments, the method further includes, responsive to sensing a new utility device located within the predetermined space in addition to the plurality of previously-sensed utility devices, determining one or more capabilities of the newly-sensed utility device with the electronic controller. The method also includes determining the plurality of system functions of the predetermined space based on the one or more capabilities of the newly-sensed utility device and the one or more capabilities of each of the plurality of previously-sensed utility devices with the electronic controller.

In some embodiments, the method further includes associating the newly-sensed utility device with the selected system function. The method also includes determining an updated control value for the newly-sensed utility device based on the selected system function and the received aspect of the predetermined space with the electronic controller. The method further includes sending a command from the electronic controller to the newly-sensed utility device to adjust to the updated control value.

In some embodiments, the method further includes, responsive to determining that one of the plurality of sensed utility devices is not available upon a subsequent attempt to sense the plurality of sensed utility devices within the predetermined space, determining the plurality of system functions of the predetermined space based on the one or more capabilities of each of the plurality of remaining sensed utility devices.

In some embodiments, the method further includes determining an updated control value for at least one of the plurality of remaining sensed utility devices with the electronic controller and sending commands from the electronic controller to the at least one of the plurality of remaining sensed utility devices to adjust to the updated control value.

Other aspects of the disclosure will become apparent by consideration of the detailed description and accompanying drawings.

### BRIEF DESCRIPTION OF THE DRAWINGS

FIG. 1 is a diagram of an environmental control system, in accordance with some embodiments.

FIG. 2A is a diagram of a first predetermined space, in accordance with some embodiments.

FIG. 2B is a diagram of a second predetermined space, in accordance with some embodiments.

FIG. 3 is a diagram of an electronic controller included in the environmental control system of FIG. 1, in accordance with some embodiments.

FIG. 4 is a flowchart of a method of controlling utility devices located within a predetermined space based on an aspect, in accordance with some embodiments.

FIG. 5 is a functional block diagram of a first light source, a second light source, and the electronic controller included in the environmental control system of FIG. 1, in accordance with some embodiments.

FIG. 6 is a flowchart of a method of dynamically generating system functions for a predetermined space, in accordance with some embodiments.

FIG. 7 is a flowchart of a method of controlling utility devices located within a predetermined space based on an aspect and system functions, in accordance with some embodiments.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

It should also be noted that a plurality of different structural components may be utilized to implement the disclosure. Furthermore, and as described in subsequent paragraphs, the specific configurations illustrated in the drawings are intended to exemplify embodiments of the disclosure. Alternative configurations are possible.

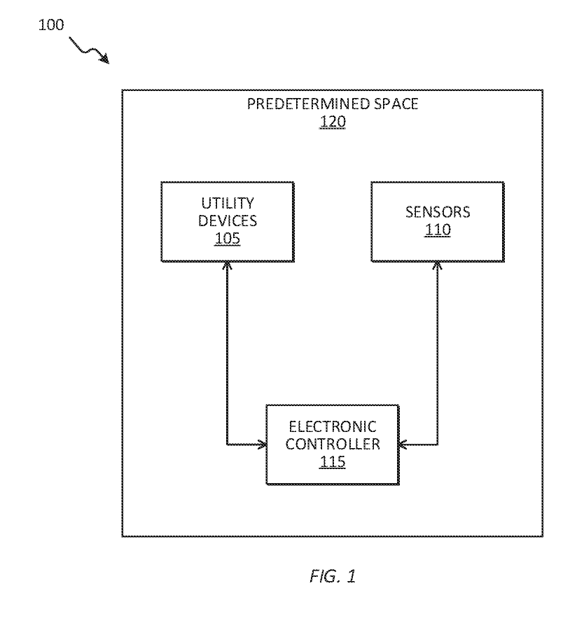

FIG. 1 is a diagram of one example embodiment of an environmental control system 100. In the illustrated embodiment, the environmental control system 100 includes utility devices 105, sensors 110, and an electronic controller 115. The utility devices 105 and the sensors 110 are located within a predetermined space 120. The predetermined space 120 may include, among other things, a structure, one or more rooms in a structure, or an outdoor area. For example, in a residential home, a living room may be one predetermined space, a kitchen may be another predetermined space, a master bedroom may be another predetermined space, and a guest bedroom may be another predetermined space. In the illustrated embodiment, the electronic controller 115 is located within the predetermined space 120. In alternate embodiments, the electronic controller 115 may be located external to the predetermined space 120.

The environmental control system 100 illustrated in FIG. 1 is provided as one example of such a system. The methods described herein may be used with environmental control systems having fewer, additional, or different components in different configurations than the environmental control system 100 illustrated in FIG. 1. For example, in some embodiments, the environmental control system 100 may include fewer or additional electronic controllers.

Communications between the various components illustrated in FIG. 1 occur over wired networks, wireless networks, or both. All or parts of these communication networks may be implemented using, for example, a cellular network, the Internet, a Bluetooth™ network, a ZigBee™ network, a Z-Wave™ network, a wireless local area network (for example, Wi-Fi), a wireless accessory Personal Area Networks (PAN), cable, an Ethernet network, satellite, a machine-to-machine (M2M) autonomous network, and a public switched telephone network. In the embodiment illustrated, components of the electronic controller 115 communicate directly with components of the utility devices 105 and the sensors 110. In alternate embodiments, components of the electronic controller 115 communicate with components of the utility devices 105 or the sensors 110 via one or more communication hubs.

The utility devices 105 manipulate environmental conditions in the predetermined space 120. The utility devices 105 include, among other things, light sources (for example, ambient lights, task lights, and accent lights), audio devices (for example, speakers), cooling devices (for example, air conditioning and fans), heating devices, window control devices (for example, shade control and tint control), display screens (for example, televisions and computer monitors), water dispensing devices (for example, sinks, showers, and bathtubs), cooking devices (for example, ovens, microwaves, stove tops, toasters, and coffee makers), cleaning devices (for example, washers, dryers, dishwashers, and autonomous cleaning robots), or a combination thereof.

Each of the utility devices 105 includes one or more control values that reflect operating conditions. For example, a basic light source may include a control value for power (i.e., ON or OFF). As a further example, a complex light source with dimming and color changing capabilities may include control values for power, dimming (for example, 50% light output), and color (for example, red light output). In some embodiments, the utility devices 105 report data to the electronic controller 115 indicating the current control values of the utility devices 105.

Operating conditions include power statuses of the utility devices 105. For example, the data can reflect whether a light source is turned ON or OFF. Operating conditions also include current operating settings of the utility devices 105. For example, the data can reflect whether a fan is oscillating or stationery, and a current speed setting (i.e., slow, medium, or fast). Operating conditions also include malfunctions of the utility devices 105. For example, the data can reflect that a light bulb is about to burn out or a leak in a kitchen sink. Operating conditions also include resource consumption information of the utility devices 105. For example, the data can reflect the energy and water usage of a washing machine.

The sensors 110 include environmental sensors that measure and report data reflecting environmental conditions in the predetermined space 120. Environmental conditions include, among other things, climate conditions (for example, temperature and humidity), interior noise levels (for example, noise generated by a speaker in the predetermined space 120 or noise generated by an occupant in the predetermined space 120), exterior noise levels (for example, noise generated by nearby traffic or weather), interior light levels (for example, light generated by a lamp or display screen), exterior light levels (for example, sunlight and light generated by street lamps), or a combination thereof. Environmental sensors include, among other things, climate sensors (for example, temperature sensors and humidity sensors), noise sensors (for example, microphones), and light sensors (for example, ambient light sensors, infrared sensors, ultraviolet sensors, and image sensors, such as charged coupled devices (CCDs) and complementary metal-oxide-semiconductors (CMOSs)).

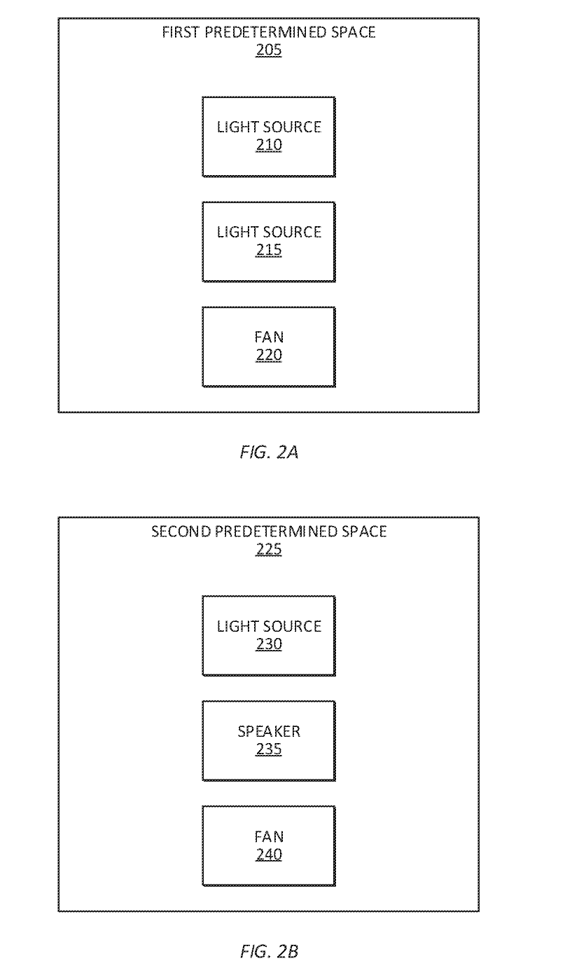

FIGS. 2A and 2B are examples of different combinations of utility devices 105 in predetermined spaces. The first predetermined space 205, illustrated in FIG. 2A, includes two light sources 210 and 215, and a fan 220. Light source 210 is a white light bulb with ON/OFF and dimming capabilities. Light source 215 is a red light bulb with ON/OFF capability. Fan 220 is a variable-speed fan with ON/OFF capability and three fan speed settings (for example, low, medium, and high). The second predetermined space 225, illustrated in FIG. 2B, includes a light source 230, a speaker 235, and a fan 240. Light source 230 is a white light bulb with ON/OFF capability. Speaker 235 is a radio with ON/OFF, volume, and tuning capabilities. Fan 240 is a dual-speed fan with ON/OFF capability and two fan speed settings (for example, low and high).

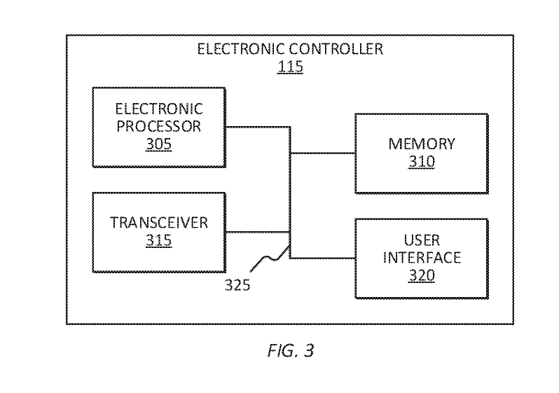

FIG. 3 is a diagram of one example embodiment of the electronic controller 115. In the illustrated embodiment, the electronic controller 115 includes an electronic processor 305 (for example, a microprocessor), memory 310, a transceiver 315, and a user interface 320. The electronic processor 305, the memory 310, as well as the other various modules are coupled by a bus 325, or are coupled directly, by one or more additional control or data buses, or a combination thereof In alternate embodiments, the electronic controller 115 may include fewer or additional components in configurations different from the configuration illustrated in FIG. 3.

The memory 310 may include read only memory (ROM), random access memory (RAM), other non-transitory computer-readable media, or a combination thereof. The electronic processor 305 is configured to retrieve program instructions and data from the memory 310 and execute, among other things, instructions to perform the methods described herein. Alternatively or in addition, the memory 310 is included in the electronic processor 305.

The transceiver 315 includes routines for transferring information between components within the electronic controller 115 and components of the utility devices 105 and the sensors 110. For example, the transceiver 315 receives data from the utility devices 105 and the sensors 110, and transmits data to the utility devices 105. In some embodiments, signals include, for example, data, data packets, control signals or any combination thereof In some embodiments, the transceiver 315 includes a separate transmitter and receiver.

The user interface 320 displays visual output generated by software applications executed by the electronic processor 305. Visual output includes, for example, graphical indicators, lights, colors, text, images, internet webpages, graphical user interfaces (GUIs), combinations of the foregoing, and the like. The user interface 320 includes a suitable display mechanism for displaying the visual output (for example, a light-emitting diode (LED) screen, a liquid crystal display (LCD) screen, an organic LED (OLED) screen, and the like). In some embodiments, the user interface 320 includes a touch sensitive interface (for example, a touch-screen display). The touch-screen display receives user input using detected physical contact (for example, detected capacitance or resistance). Based on the user input, the touch-screen display outputs signals to the electronic processor 305 which indicate positions on the touch-screen display currently being selected by physical contact. Alternatively or in addition, the user interface 320 receives user input from a plurality of input devices such as a microphone, keyboard, a mouse, a trackpad, and the like. In some embodiments, the user interface 320 is separate from the electronic controller 115. For example, the user interface 320 can include a portable communication device carriable by a user (i.e., a smart phone).

In some embodiments, the term “electronic controller” is defined as the combination of software and hardware included in one or more electrical computing devices that runs application service processes. For example, the electronic controller 115 can be defined as the combination of software and hardware included in one or more electrical computing devices that runs application processes of the methods described herein. In addition, the functionality described herein as being performed by a single electronic controller may be distributed among a plurality of electronic controllers. For example, the functionality performed by the electronic controller 115 described herein (or a portion thereof) may be distributed among a plurality of electronic controllers.

Conventional device control systems require input commands that are tied to specific devices (or groups of devices). For example, when controlling light sources, conventional device control systems require users to identify a specific light source (or a specific group of light sources) to which input commands are directed to. In other words, conventional device control systems require input commands such as “turn on the kitchen lights” or “turn on the living room lights.” Further, conventional device control systems are unable to automatically adapt to device changes. For example, when an old light source is replaced with a new one, conventional device control systems require the user to define the new device.

The electronic controller 115 executes control interactions with the utility devices 105 in a predetermined space 120 based on received aspects. An aspect is a desired (or target) environmental condition that is defined for a predetermined space (for example, a lighting condition, an audio condition, or a climate condition). Example aspects include “lights on,” “music on,” and “temperature to 70 degrees.” Aspects can be general or specific. For example, a general aspect can be “lights on,” and specific aspects can be “lights at 40%” or “red light.” As a further example, general aspects can be “play music” or “play jazz,” and specific aspects can be “play music at 40% volume” or “play So What by Miles Davis.”

Unlike the device-specific input commands required by conventional device control systems, aspects are not tied to specific devices. For example, a device-specific input command can be “turn on the kitchen lights” whereas an aspect can be “turn on lights.” The electronic controller 115 enables aspect-based control by automatically determining which utility devices 105 in the predetermined space 120 are capable of producing the desired environmental condition, and then performing control interactions with the identified utility devices 105 to achieve the desired environmental condition.

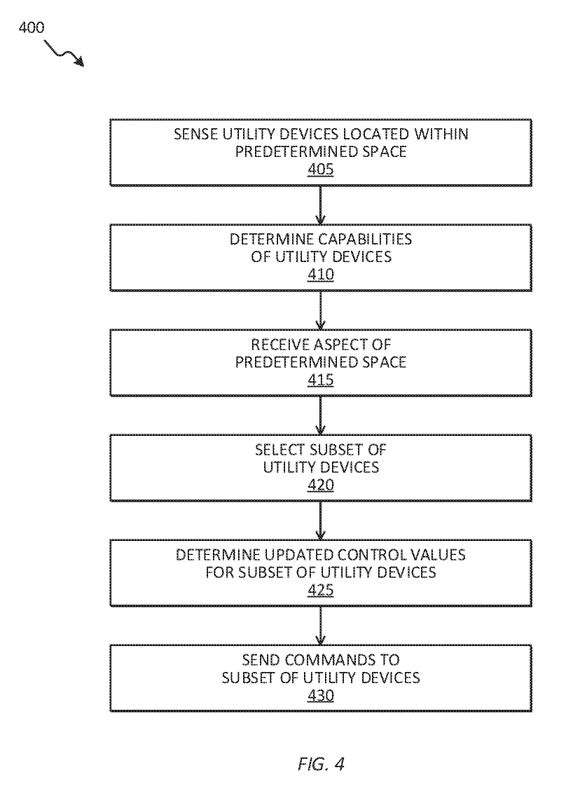

FIG. 4 illustrates an example method 400 of controlling utility devices 105 located within a predetermined space 120 based on aspects. In the example illustrated, the method 400 includes the electronic controller 115 sensing the utility devices 105 located within the predetermined space 120 (at block 405). For example, with reference to FIG. 2A, the electronic controller 115 senses the two light sources 210 and 215, and the fan 220 located within the first predetermined space 205. In some embodiments, the electronic controller 115 senses the utility devices 105 located within the predetermined space 120 by sending query signals and listening for response signals sent by the utility devices 105. For example, with reference to FIG. 2A, the electronic controller 115 sends a query signal to the two light sources 210 and 215 and the fan 220 in the first predetermined space 205. Responsive to receiving the query signal, the two light sources 210 and 215 and the fan 220 send response signals to the electronic controller 115. Alternatively or in addition, the electronic controller 115 senses the utility devices 105 located within the predetermined space 120 via a handshaking process.

In some embodiments, the size (and/or boundary) of the predetermined space 120 is defined by the detection range of the electronic controller 115. In order words, the maximum transmission range of the transceiver 315 in the electronic controller 115 may define the predetermined space 120. For example, when the electronic controller 115 is located outdoors, the detection range of the electronic controller 115 defines the predetermined space 120. Alternatively or in addition, the predetermined space 120 is defined by physical structures. For example, when the electronic controller 115 is able to sense the utility devices 105 that are located anywhere inside a room, the room may define the predetermined space 120.

At block 410, the electronic controller 115 determines the capabilities of the utility devices 105 located within the predetermined space 120. For example, with reference to FIG. 2A, the electronic controller 115 may determine that light source 210 includes ON/OFF control and dimming capabilities, light source 215 includes ON/OFF control, and fan 220 includes ON/OFF control and three fan speed settings (for example, low, medium, and high). In some embodiments, the utility devices 105 send data to the electronic controller 115 indicating their capabilities. Alternatively or in addition, the electronic controller 115 determines the capabilities of the utility devices 105 based on identifying data (for example, model numbers) received from the utility devices 105. For example, the electronic controller 115 queries the model numbers of the utility devices 105 to a look-up table (for example, stored in memory 310) which provides the capabilities of the utility devices 105.

At block 415, the electronic controller 115 receives an aspect of the predetermined space 120. As described above, an aspect is a desired (or target) environmental condition that is defined for the predetermined space 120 (for example, a lighting condition, an audio condition, or a climate condition). For example, the electronic controller 115 receives an aspect of “turn on the lights.” In some embodiments, the electronic controller 115 receives the aspect via the user interface 320. For example, a user speaks the phrase “turn on the lights” into a microphone (included in some embodiments of the user interface 320). Alternatively or in addition, the electronic controller 115 receives the aspect via the transceiver 315.

Responsive to receiving the aspect, the electronic controller 115 selects a subset of the utility devices 105 to execute the desired environmental conditions defined by the received aspect (at block 420). In some embodiments, the electronic controller 115 selects the subset of utility devices 105 based on the determined capabilities of the utility devices 105. For example, with reference to FIG. 2A, the electronic controller 115 may select the two light sources 210 and 215 when the received aspect is “turn on the lights.” As a further example, the electronic controller 115 may only select light source 210 when the received aspect is “turn on the lights to 30%” because light source 210 has dimming capabilities and light source 215 does not. As an additional example, the electronic controller 115 may select fan 220 when the received aspect is “set the fan to medium.”

At block 425, the electronic controller 115 determines updated control values for the selected subset of utility devices 105 based on the received aspect. In other words, the electronic controller 115 determines the physical state changes that are needed in each of the selected subset of utility devices 105 to achieve the desired environmental condition defined by the received aspect. For example, with reference to FIG. 2A, when the received aspect is “turn on the lights,” the electronic controller 115 may determine that the ON/OFF control values for light sources 210 and 215 should be changed from OFF to ON. As a further example, when the received aspect is “turn on the lights to 30%,” the electronic controller 115 determines that the ON/OFF control value for light source 210 should be changed from OFF to ON and the output intensity control value for light source 210 should be set to 30 percent.

Alternatively or in addition, the electronic controller 115 determines updated control values for the selected subset of utility devices 105 based on the data from the sensors 110 indicating environmental conditions in or near the predetermined space 120. For example, when a lighting-based aspect is executed by multiple light sources in the predetermined space 120, the electronic controller 115 may use data from optical sensors to determine the composite result of the multiple light sources such that the control values can be adjusted to achieve the aspect.

At block 430, the electronic controller 115 sends commands to the selected subset of utility devices 105 to adjust to the updated control values. For example, with reference to FIG. 2A, when the received aspect is “turn on the lights,” the electronic controller 115 sends commands to light sources 210 and 215 which cause light sources 210 and 215 to turn ON. As a further example, when the received aspect is “turn on the lights to 30%,” the electronic controller 115 sends commands to light source 210 which causes light source 210 to turn ON and emit light at 30 percent. In some embodiments, the electronic controller 115 sends the commands to the selected subset of utility devices 105 via the transceiver 315.

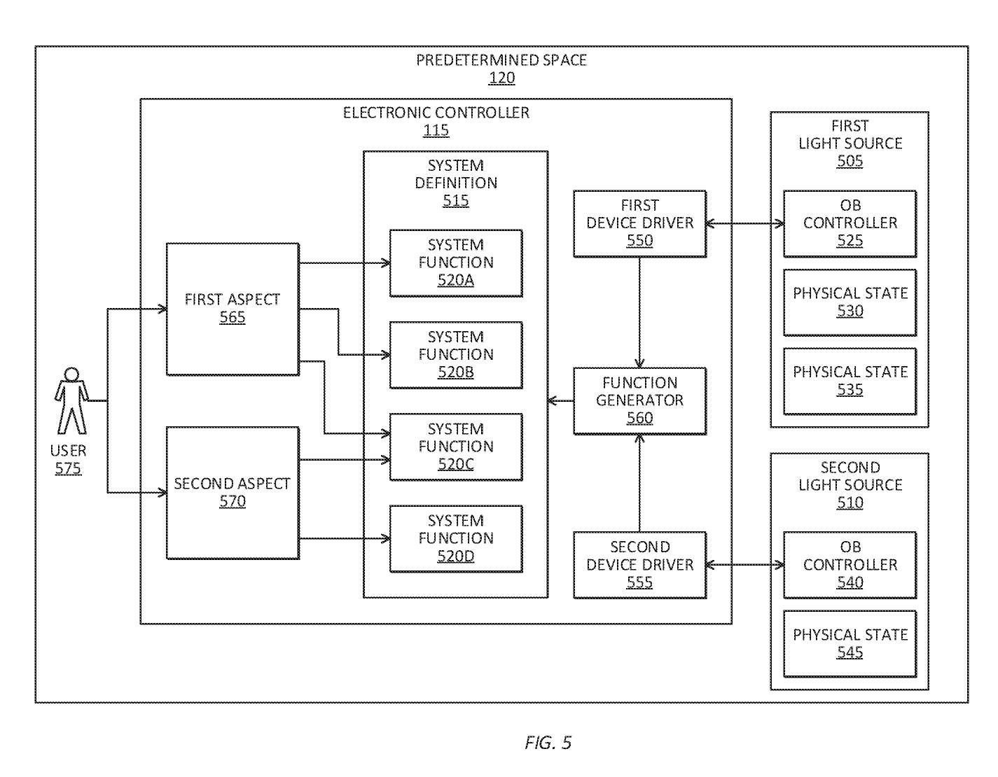

FIG. 5 is an example functional block diagram of the electronic controller 115, a first light source 505, and a second light source located 510 located within an example embodiment of the predetermined space 120. In some embodiments, the electronic controller 115 constructs a system definition 515 for the predetermined space 120. The system definition 515 includes a plurality of system functions 520A through 520D for the predetermined space 120. Each of the system functions 520A through 520D represent an available operational aspect of the utility devices 105 located within the predetermined space 120. For example, system function 520A may represent light intensity (i.e., light output level), system function 520B may represent light power (i.e., ON and OFF), and system function 520C may represent light color (for example, white, red, green, yellow, etc.). As will be described below, the electronic controller 115 determines the plurality of system functions 520A through 520D based on the capabilities of the utility devices 105 located within the predetermined space 120.

The first light source 505 includes an onboard (OB) controller 525 and two physical states 530 and 535. The OB controller 525 controls the operation of the first light source 505. The two physical states 530 and 535 represent different attributes of the first light source 505 that can be modified. For example, if the first light source 505 is a white light bulb that is dimmable, physical state 530 can represent the power state of the first light source 505 (i.e., whether the first light source 505 is turned ON or OFF) and physical state 535 can represent the light dimming level of the first light source 505 (for example, light output at 50%, light output at 100%, light output at 25%, etc.).

The second light source 510 includes an onboard (OB) controller 540 and one physical state 545. The OB controller 540 controls the operation of the second light source 510. The physical state 545 represents an attribute of the second light source 510 that can be modified. For example, if the second light source 510 is a red light bulb that is not dimmable, physical state 545 can represent the power state of the second light source 510 (i.e., whether the second light source 510 is turned ON or OFF).

The electronic controller 115 illustrated in FIG. 5 includes the system definition 515, a first device driver 550, a second device driver 555, a function generator 560, a first aspect 565, and a second aspect 570. The first device driver 550, the second device driver 555, and other device drivers (not illustrated) communicate with the utility devices 105 to determine the capabilities of the utility devices 105 (i.e., the available physical states of the utility devices 105). For example, the first device driver 550 communicates with the OB controller 525 of the first light source 505 and determines that the first light source 505 is a white light bulb that is dimmable. As a further example, the second device driver 555 communicates with the OB controller 540 of the second light source 510 and determines that the second light source 510 is a red light bulb with ON/OFF functionality.

The function generator 560 determines the system functions 520A through 520D based on the capabilities of the utility devices 105 located within the predetermined space 120. For example, with reference to the first light source 505 in FIG. 5, the function generator 560 adds a system function for light power and a system function for light intensity. In addition, the function generator 560 maps the functionality of the utility devices 105 to existing system functions. For example, with reference to the second light source 510, the function generator 560 maps the ON/OFF functionality to the system function for light power that was previously created for the first light source 505.

The utility devices 105 can include capabilities that are not directly related to a physical state that can be modified. For example, the second light source 510 is a red light bulb, and, thus, can emit red-colored light. The utility devices 105 can also include capabilities that are not directly related to their primary function. For example, microwaves typically include display screens that emit light. In some embodiments, the function generator 560 generates system functions and maps the extended capabilities of the utility devices 105 such as those described herein.

The electronic controller 115 also maps each received aspect to the system functions that are necessary to accomplish the desired physical output defined by each aspect. For example, as illustrated in FIG. 5, the first aspect 565 is mapped to system functions 520A, 520B, and 520C, and the second aspect 570 is mapped to system functions 520C and 520D. In some embodiments, the electronic controller 115 determines the grouping of system functions that are necessary to accomplish the desired physical output defined by each aspect. Alternatively or in addition, aspects may include indications of the system functions that they require. In some embodiments, as illustrated in FIG. 5, the electronic controller 115 receives aspects (for example, the first aspect 565 and the second aspect 570) from a user 575 over the user interface 320 or via the transceiver 315. Alternatively or in addition, the electronic controller 115 receives aspects from other sources.

The environmental control system 100 described herein does not require users of clients to be aware of which physical devices are being used to accomplish an aspect of the predetermined space 120 during control. Thus, the specific physical topology of the utility devices 105 included in the environmental control system 100 can be replaced or changed to another dynamically without any modification of the client or rediscovery. When the utility devices 105 are replaced or new devices are added, the electronic controller 115 remaps or expands the system definition 515 based upon the detected changes automatically without user intervention. Further, as new utility devices are added to the predetermined space 120, the electronic controller 115 maps those device's functions to aspects which require it.

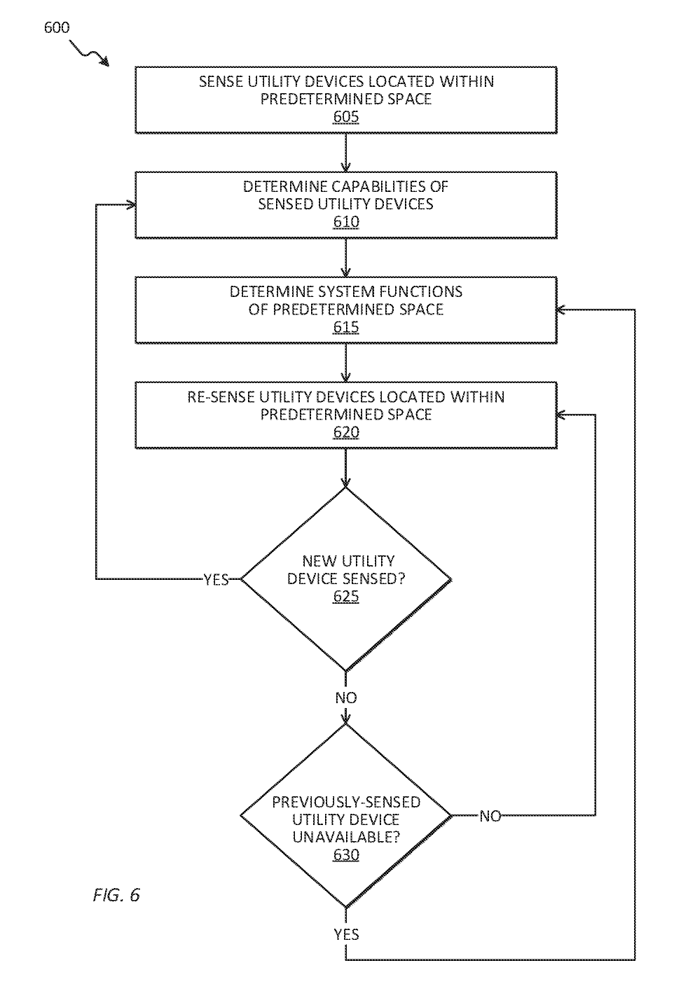

FIG. 6 illustrates an example method 600 of dynamically generating system functions for the predetermined space 120. In the example illustrated, the method 600 includes the electronic controller 115 sensing the utility devices 105 located within the predetermined space 120 (at block 605). In some embodiments, the electronic controller 115 senses the utility devices 105 located within the predetermined space 120 via one or a combination of the methods described herein in relation to block 405 in FIG. 4.

At block 610, the electronic controller 115 determines the capabilities of the utility devices 105 located with the predetermined space 120. In some embodiments, the electronic controller 115 senses the capabilities of the utility devices 105 located within the predetermined space 120 via one or a combination of the methods described herein in relation to block 410 in FIG. 4.

At block 615, the electronic controller 115 determines system functions for the predetermined space 120 based on the capabilities of the utility devices 105 located within the predetermined space 120. In some embodiments, the electronic controller 115 creates separate system functions for each type of capability available in one or more of the utility devices 105. For example, with reference to FIG. 2A, the electronic controller 115 may create a light power system function for the power ON/OFF capability of light sources 210 and 215, and a light intensity system function for the dimming capability of light source 210. Alternatively or in addition, in some embodiments, the electronic controller 115 creates separate system functions to control similar types of capabilities in different types of utility devices 105. For example, with reference to FIG. 2B, the electronic controller 115 may create a light power system function for the power ON/OFF capability of light source 230, an audio power system function for the power ON/OFF capability of speaker 235, and a climate power system function for the power ON/OFF capability of fan 240.

Each system function is associated with a subset of the utility devices 105 located within the predetermined space 120. More specifically, each system function is associated with the subset of utility devices 105 that possess the capability controlled by the system function. For example, with reference to FIG. 2A, a light power system function is associated with light sources 210 and 215 because light sources 210 and 215 both includes power ON/OFF capabilities.

At block 620, the electronic controller 115 senses (or re-senses) the utility devices 105 located within the predetermined space 120. In some embodiments, the electronic controller 115 re-senses the utility devices 105 located within the predetermined space 120 by sending query signals and listening for response signals sent by the utility devices 105. Alternatively or in addition, in some embodiments, the electronic controller 115 re-senses the utility devices 105 located within the predetermined space 120 via a handshaking process.

At block 625, the electronic controller 115 determines whether a new utility device is located within the predetermined space 120. In some embodiments, the electronic controller 115 determines that a new utility device is located within the predetermined space 120 when the electronic controller 115 receives a response signal from an unknown utility device. For example, with reference to FIG. 2A, the electronic controller 115 may determine that a second fan (not pictured) is placed within the first predetermined space 205 responsive to receiving a response signal from the second fan.

When a new utility device is sensed, the method 600 returns to block 610 and the electronic controller 115 determines the capabilities of the newly-sensed utility device. Subsequently, the electronic controller 115 determines (or updates) the system functions (at block 620). For example, with reference to FIG. 2B, responsive to sensing the addition of the speaker 235 to the second predetermined space 225, the electronic controller 115 may determine new system functions based on the capabilities of the speaker 235. As a further example, with reference to FIG. 2A, responsive to sensing the addition of light source 215 to the first predetermined space 205, the electronic controller 115 may update an existing light power system function (previously generated for light source 210) to associate with light source 215.

Alternatively, when a new utility device is not sensed, the electronic controller 115 determines whether any previously-sensed utility devices are not available (at block 630). For example, a previously-sensed utility device may be removed from the predetermined space 120 or may become inoperable. In some embodiments, the electronic controller 115 determines that a previously-sensed utility device is not available within the predetermined space 120 when the electronic controller 115 fails to receive a response signal from that utility device. For example, with reference to FIG. 2A, when light source 210 is removed from the first predetermined space 205, the electronic controller 115 does not receive a response signal from light source 210.

When all of the previously-sensed utility devices are re-sensed, the method 600 returns to block 620 and the electronic controller 115 again re-senses the utility devices 105 located within the predetermined space 120. Alternatively, when one or more of the previously-sensed utility devices are not re-sensed, the method 600 returns to block 615 and the electronic controller 115 re-determines the system functions. For example, when a light source with dimming functionality is no longer available and only light sources with ON-OFF functionality remain, the electronic controller 115 may remove the system function controlling light intensity because that system functionality is no longer available.

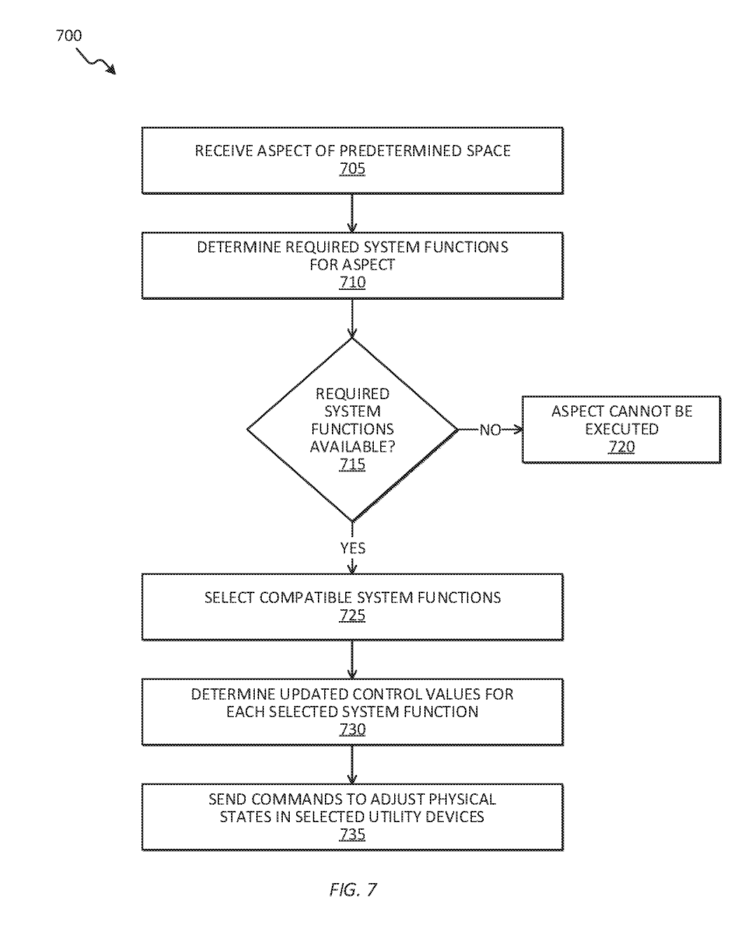

FIG. 7 illustrates an example method 700 of controlling utility devices 105 located within a predetermined space 120 based on a received aspect. In the example illustrated, the method 700 includes the electronic controller 115 receiving an aspect of the predetermined space 120 (at block 705). In some embodiments, the electronic controller 115 receives the aspect via the user interface 320. For example, a user speaks the phrase “turn on music” into a microphone (included in some embodiments of the user interface 320). Alternatively or in addition, the electronic controller 115 receives the aspect via the transceiver 315.

At block 710, the electronic controller 115 determines required system functions that are necessary to execute the received aspect. For example, the electronic controller 115 may determine that a “turn on lights to 50%” aspect needs a system function for light power and a system function for light intensity. As a further example, the electronic controller 115 may determines that a “turn on music” aspect needs a system function for audio power, a system function for audio volume, and a system function for audio tuning.

At block 715, the electronic controller 115 determines when the required system functions that are necessary to execute the received aspect are available. For example, as described herein in reference to FIG. 2A, light source 210 in the first predetermined space 205 includes ON/OFF functionality and dimming functionality. Thus, system functions for light power and light intensity required by a “turn on lights to 50% aspect” are available in the first predetermined space 205. As a further example, with reference to FIG. 2B, the second predetermined space 225 may only include a single light source with only ON/OFF functionality (i.e., light source 230). Thus, the system function for light power is available and the system function for light intensity is not available in the second predetermined space 225.

When any (or all) of the required system functions are not available, the aspect cannot be executed (at block 720). For example, as described herein with reference to FIG. 2B, light source 230 in the second predetermined space 225 only includes ON/OFF functionality (i.e., no dimming functionality). Thus, the electronic controller 115 may determine that a “turn on lights to 50%” aspect cannot be executed in the second predetermined space 225 because the system function for light intensity is not available in the second predetermined space 225. In some embodiments, the electronic controller 115 provides an indication when an aspect cannot be executed. For example, the electronic controller 115 may provide an auditory or visual indication via the user interface 320.

Alternatively, when all of the required system functions are available, the electronic controller 115 selects the required system functions from all of the available system functions (at block 725). For example, with reference to FIG. 2A, when a “turn on lights to 50%” aspect is received in the first predetermined space 205, the electronic controller 115 may select the light power system function and the light intensity system function. As a further example, with reference to FIG. 2B, when a “turn on music” aspect is received in the second predetermined space 225, the electronic controller 115 may select an audio power system function, an audio volume system function, and an audio tuning system function.

At block 730, the electronic controller 115 determines updated control values for each of the selected system functions. In other words, the electronic controller 115 determines a type of psychical state change that should be executed by each utility device that is associated with the selected system functions. For example, a “turn on lights” aspect may require a light power system function to change from power OFF control value to a power ON control value. As a further example, a “turn on music at 50% volume” aspect may require, among other things, an audio level system function to update its control value to fifty percent.

At block 735, the electronic controller 115 sends commands to the selected subset of utility devices 105 to adjust to the updated control values. As described above, each system function is associated with a subset of the utility devices 105. For example, an audio power system function may be associated with each audio device included in the utility devices 105. Thus, the electronic controller 115 sends commands to each of the utility devices 105 associated with the selected system functions.

In some embodiments, the electronic controller 115 sends the same command to each of the utility devices 105 associated with selected system function. However, in some situations, different utility devices may require different commands (or different types of commands) to adjust the same physical state. For example, with reference to FIG. 2A, the power ON command for light source 210 may be different from the power ON command for light source 215 in the first predetermined space 205. The difference in commands may be due to the utility devices 105 being from different manufactures or using different communication standards (for example, Wi-Fi, Bluetooth™, ZigBee™, and Z-Wave™). Thus, in some embodiments, the electronic controller 115 sends different commands to different subsets of the utility devices 105 associated with the selected system function to adjust to the updated control value for the selected system function. In some embodiments, the electronic controller 115 uses device drivers to determine specific commands to send to the utility devices 105. For example, with reference to FIG. 5, the electronic controller 115 may use the first device driver 550 to determine appropriate commands to send to the first light source 505 and the second device driver 555 to determine appropriate commands to send to the second light source 510.

In some embodiments, the electronic controller 115 determines the commands to send based on data from the sensors 110 located within the predetermined space 120. For example, the electronic controller 115 may use data from one or more temperature sensors to determine commands to send to a temperature-controlling utility device when an aspect indicates a specific temperature.

This disclosure is not limited in its application to the examples provided, the embodiments discussed, or to the details of construction and the arrangement of components set forth in the foregoing description or drawings. The disclosure is capable of other embodiments and of being practiced or of being carried out in various ways.

What is claimed is:

1. An environmental control system comprising:
a plurality of utility devices located within a predetermined space,
wherein the plurality of utility devices are configured to manipulate one or more environmental conditions of the predetermined space and report data reflecting control values of the plurality of utility devices; and
an electronic controller,
wherein the electronic controller is configured to
sense the plurality of utility devices located within the predetermined space,
determine one or more capabilities of each of the plurality of sensed utility devices, and
determine a plurality of system functions of the predetermined space based on the one or more capabilities of each of the plurality of sensed utility devices, wherein each of the plurality of system functions is associated with a subset of sensed utility devices included in the plurality of sensed utility devices,
wherein responsive to receiving an aspect of the predetermined space, the electronic controller is configured to
select a system function from the plurality of system functions based on the received aspect of the predetermined space, wherein the selected system function is associated with a first subset of sensed utility devices included in the plurality of sensed utility devices,
determine updated control values for the first subset of sensed utility devices based on the selected system function and the received aspect of the predetermined space, and
send commands to the first subset of sensed utility devices to adjust to the updated control values.

2. The environmental control system of claim 1, wherein responsive to sensing a new utility device located within the predetermined space in addition to the plurality of previously-sensed utility devices, the electronic controller is further configured to
determine one or more capabilities of the newly-sensed utility device, and
determine the plurality of system functions of the predetermined space based on the one or more capabilities of the newly-sensed utility device and the one or more capabilities of each of the plurality of previously-sensed utility devices.

3. The environmental control system of claim 2, wherein the electronic controller is further configured to
associate the newly-sensed utility device with the selected system function,
determine an updated control value for the newly-sensed utility device based on the selected system function and the received aspect of the predetermined space, and
send a command to the newly-sensed utility device to adjust to the updated control value.

4. The environmental control system of claim 1, wherein responsive to determining that one of the plurality of sensed utility devices is not available upon a subsequent attempt to sense the plurality of sensed utility devices within the predetermined space, the electronic controller is configured to
determine the plurality of system functions of the predetermined space based on the one or more capabilities of each of the plurality of remaining sensed utility devices.

5. The environmental control system of claim 4, wherein the electronic controller is further configured to
determine an updated control value for at least one of the plurality of remaining sensed utility devices, and
send a command to the at least one of the plurality of remaining sensed utility devices to adjust to the updated control value.

6. The environmental control system of claim 1, wherein the received aspect of the predetermined space includes one or more preferred environmental conditions of the predetermined space.

7. The environmental control system of claim 6, wherein the received aspect of the predetermined space is without identifiers for the plurality of sensed utility devices.

8. The environmental control system of claim 1, wherein the electronic controller is further configured to determine the plurality of system functions of the predetermined space without receiving explicit commands from a user.

9. An environmental control system comprising:
a plurality of utility devices located within a predetermined space,
wherein the plurality of utility devices are configured to manipulate one or more environmental conditions of the predetermined space and report data reflecting one or more control values of the plurality of utility devices; and
an electronic controller,
wherein the electronic controller is configured to
sense the plurality of utility devices located within the predetermined space, and
determine one or more capabilities of each of the plurality of sensed utility devices,
wherein responsive to receiving an aspect of the predetermined space, the electronic controller is configured to
select a subset of sensed utility devices included in the plurality of sensed utility devices based on the received aspect of the predetermined space and the one or more capabilities of each of the plurality of sensed utility devices,
determine one or more updated control values for the selected subset of sensed utility devices based on the received aspect of the predetermined space, and
send commands to the selected subset of sensed utility devices to adjust to the one or more updated control values.

10. The environmental control system of claim 9, wherein the received aspect of the predetermined space includes one or more preferred environmental conditions of the predetermined space.

11. The environmental control system of claim 10, wherein the received aspect of the predetermined space is without identifiers for selected subset of sensed utility devices.

12. A method of controlling a plurality of utility devices located within a predetermined space, the method comprising:
sensing the plurality of utility devices located within the predetermined space with an electronic controller;
determining one or more capabilities of each of the plurality of sensed utility devices with the electronic controller; and
responsive to receiving an aspect of the predetermined space at the electronic controller,
selecting a first subset of sensed utility devices included in the plurality of sensed utility devices based on the received aspect of the predetermined space and the one or more capabilities of each of the plurality of sensed utility devices,
determining one or more updated control values for the first subset of sensed utility devices based on the received aspect of the predetermined space with the electronic controller, and
sending commands from the electronic controller to the first subset of sensed utility devices to adjust to the one or more updated control values.

13. The method of claim 12, wherein the received aspect of the predetermined space includes one or more preferred environmental conditions of the predetermined space.

14. The method of claim 13, wherein the received aspect of the predetermined space is without identifiers for the plurality of sensed utility devices.

15. The method of claim 12, further comprising
determining a plurality of system functions of the predetermined space based on the one or more capabilities of each of the plurality of sensed utility devices with the electronic controller, wherein each of the plurality of system functions is associated with a subset of sensed utility devices included in the plurality of sensed utility devices; and
wherein response to receiving the aspect of the predetermined space at the electronic controller,
selecting a system function from the plurality of system functions based on the received aspect of the predetermined space with the electronic controller, wherein the selected system function is associated with the first subset of sensed utility devices,
determining the one or more updated control values for the first subset of sensed utility devices based on the selected system function and the received aspect of the predetermined space, and
sending commands from the electronic controller to the first subset of sensed utility devices to adjust to the one or more updated control values.

16. The method of claim 15, further comprising
determining the plurality of system functions of the predetermined space with the electronic controller without receiving explicit commands from a user.

17. The method of claim 15, wherein the method further comprising
responsive to sensing a new utility device located within the predetermined space in addition to the plurality of previously-sensed utility devices,
determining one or more capabilities of the newly-sensed utility device with the electronic controller; and
determining the plurality of system functions of the predetermined space based on the one or more capabilities of the newly-sensed utility device and the one or more capabilities of each of the plurality of previously-sensed utility devices with the electronic controller.

18. The method of claim 17, wherein the method further comprising
associating the newly-sensed utility device with the selected system function;
determining an updated control value for the newly-sensed utility device based on the selected system function and the received aspect of the predetermined space with the electronic controller; and
sending a command from the electronic controller to the newly-sensed utility device to adjust to the updated control value.

19. The method of claim 15, wherein the method further comprising
responsive to determining that one of the plurality of sensed utility devices is not available upon a subsequent attempt to sense the plurality of sensed utility devices within the predetermined space, determining the plurality of system functions of the predetermined space based on the one or more capabilities of each of the plurality of remaining sensed utility devices.

20. The method of claim 19, wherein the method further comprising
determining an updated control value for at least one of the plurality of remaining sensed utility devices with the electronic controller; and
sending commands from the electronic controller to the at least one of the plurality of remaining sensed utility devices to adjust to the updated control value.
